(19) United States
(12) Patent Application Publication
(10) Pub. No.: US 2006/0085383 A1
(43) Pub. Date: Apr. 20, 2006

(54) Network-based data collection, including local data attributes, enabling media management without requiring a network connection

(75) Inventors: Michael W. Mantle, San Rafael, CA (US); Brian T. Hamilton, Pleasanton, CA (US); Peter C. Dimaria, Berkeley, CA (US)

Correspondence Address: STAAS & HALSEY LLP, SUITE 700, 1201 NEW YORK AVENUE, N.W., WASHINGTON, DC, 20005, US

(73) Assignee: Gracenote, Inc., Emeryville, CA (US)

(21) Appl. No.: 11/243,997

(22) Filed: Oct. 6, 2005

Related U.S. Application Data
(60) Provisional application No. 60/615,956, filed on Oct. 6, 2004.

(51) Int. Cl. G06F 17/30

(52) U.S. Cl. 707/1

(57) ABSTRACT

Consistent user experience of playlist capabilities, despite differences in available resources and on-line connectivity, is provided. Data embedded in a playback device compensates for lack of connectivity. For compactness, embedded data can be targeted to geographic region(s) by selecting metadata for recordings containing audio using statistics on playback of the recordings in many geographic regions. The statistics and corresponding metadata are segregated by the geographic regions. Then a portion of the corresponding metadata is selected for at least one of the geographic regions based on the statistics. By using statistics that indicate popularity of recordings within geographic regions based on frequency of playback or requests for information about a recording when it is played, the portion of the corresponding metadata that is selected can be tailored for individual geographic regions. To ensure that subregions and genres are not totally excluded, the portion selected may not be solely based on popularity.

### CROSS REFERENCE TO RELATED APPLICATIONS

This application is related to U.S. patent application Ser. No. 10/228,261, filed Aug. 27, 2003 by Paul QUINN et al. which is entitled PLAYLIST GENERATION, DELIVERY AND NAVIGATION and U.S. provisional application entitled PLAYLIST AND MUSIC MANAGEMENT FOR DEVICES, having Ser. No. 60/314,664, by Paul Quinn et al., filed Aug. 27, 2001. The application is related to and claims priority to SYSTEM FOR NETWORK-BASED MEDIA MANAGEMENT WITH LOCAL DATA ATTRIBUTES TO ALLOW FUNCTIONING WHEN NO NETWORK CONNECTION IS AVAILABLE OR POSSIBLE, having Ser. No. 60/615,956, by Michael W. Mantle et al., filed Oct. 6, 2004. All of the related applications listed above are incorporated by reference herein.

### BACKGROUND OF THE INVENTION

A system is described that can provide advanced media management capabilities to devices that play back media (e.g., digital audio files, digital video files, digital photos, etc.) Providing a system that can work effectively and “perceptually” consistently for users but having vastly different resources is a very difficult problem. This “user consistent media management system” addresses this problem by providing network-based resources, or local data attributes and limited resources, when network connectivity is not available or possible.

PC-based media players (e.g., RealOne, Apple® iTunes®, WindowsMedia® Player, WinAmp®, etc.) provide media management capabilities using the local file system of the PC. They access information using network connectivity (e.g., to access CDDB® or other online music/DVD information services) and store the metadata associated with the media (e.g., digital songs, videos, etc.) on the local file system. These media players have varying levels of local data available, and (generally) provide little additional information other than data provided by the digital song file name and data tags (i.e., ID3 tags).

### SUMMARY OF THE INVENTION

It is an aspect of the invention to create a consistent user experience for a range of consumer electronics devices, regardless of their on-line connectivity capabilities or local storage capacity.

It is another aspect of the invention to make playlist creation easy in stand alone or disconnected playback devices.

It is a further aspect of the invention to provide metadata in a small memory space that can be used for playlist creation for a broad range of recordings.

The above aspects can be attained by a method of selecting metadata for recordings containing audio, including collecting statistics on playback of the recordings in a plurality of geographic regions; segregating the statistics and corresponding metadata by the geographic regions; and selecting a portion of the corresponding metadata for one of the geographic regions based on the statistics. By using statistics that indicate popularity of recordings within geographic regions based on frequency of playback or requests for information about a recording when it is played, the portion of the corresponding metadata that is selected can be tailored for individual geographic regions. Preferably, the selecting is not limited to popularity, so that subregions and genres are not totally excluded.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of a computer-based media player system.

FIGS. 2A-2D are block diagrams of consumer electronics media player systems.

FIG. 3 is a block diagram of a system for collecting information about recordings played throughout the world.

FIG. 4 is a data flow diagram showing selection of data on a regional basis from the information collected by the system illustrated in FIG. 3.

FIG. 5 is a block diagram of the system illustrated in FIG. 3 showing an example of the regions used in the process illustrated in FIG. 4.

FIGS. 6 and 7 are examples of ROM contents for different regions.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

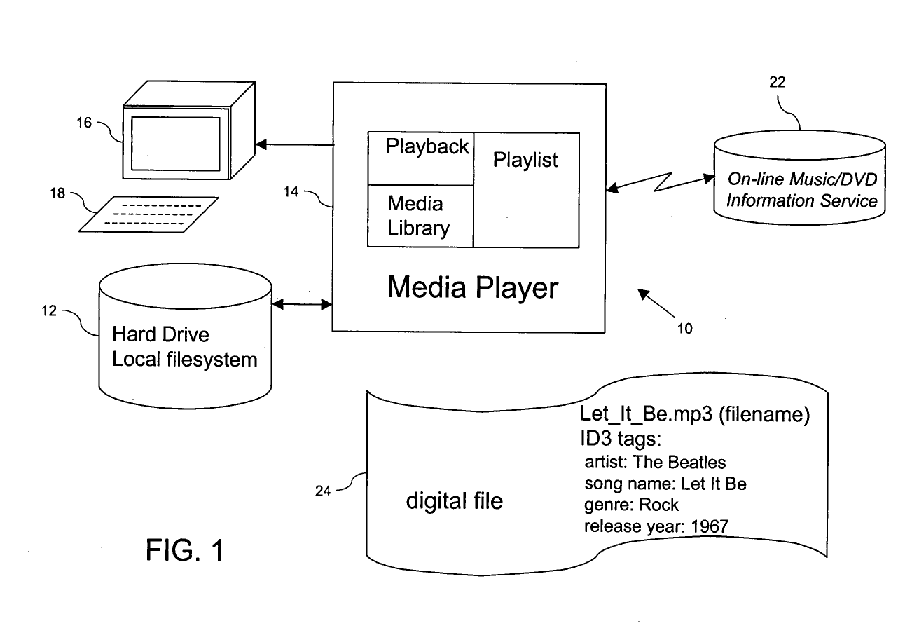

FIG. 1 is a block diagram of a media player system 10 using a personal computer (PC) having a local hard drive 12, memory 14 and I/O devices 16, 18. If the PC is connected to a network 20 it can access additional information available at on-line music/DVD information service 22 and store that data locally on hard drive 12 or using a local (LAN) or wide-area network (WAN) file system (not shown).

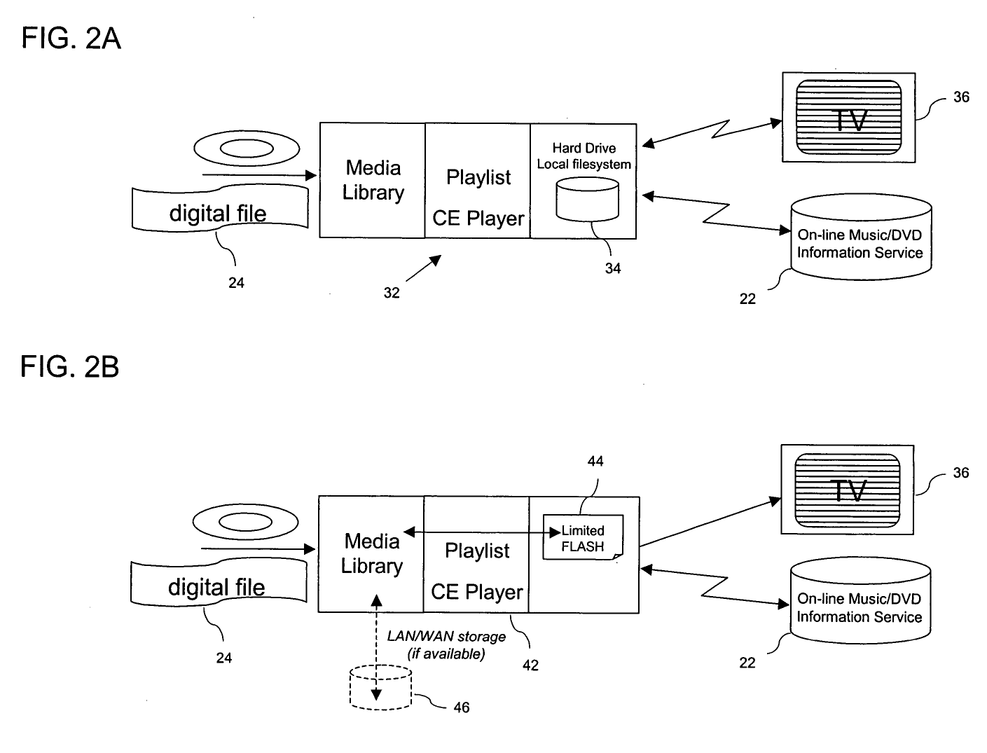

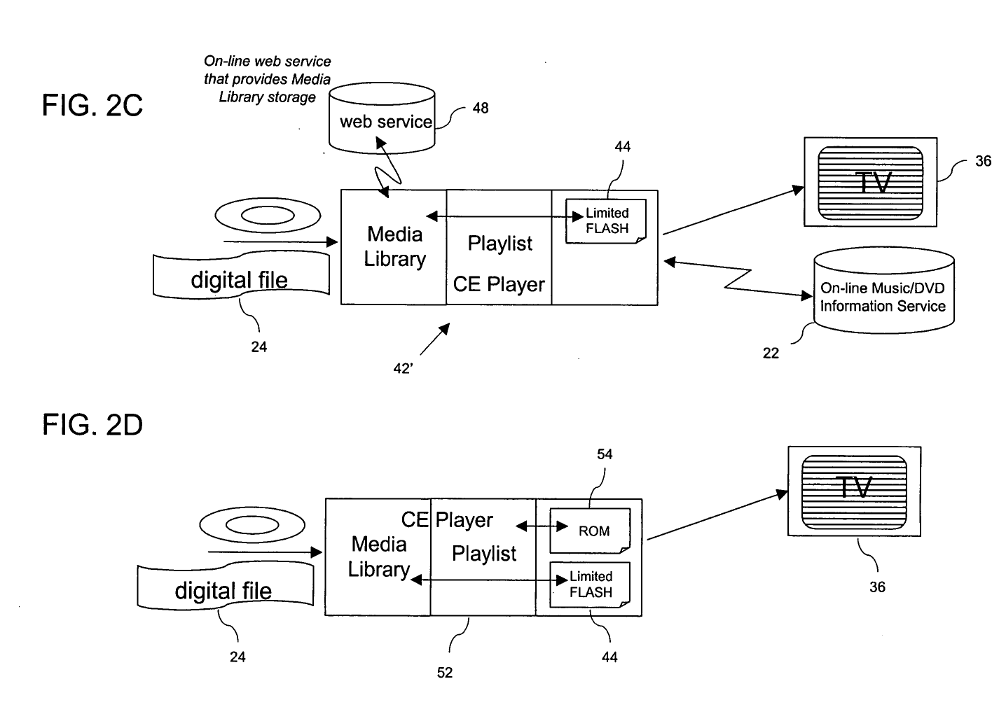

Moving this capability to consumer electronics (CE) products that have an inconsistent set of resources and still provide a perceptually similar experience of managing media requires a different approach to the problem and partitioning the problem into classes of devices. FIGS. 2A-2D show these classes. To provide a user a consistent experience with all four of these classes of devices requires a change of resource utilization and creative ways to augment brute force local file storage and retrieval methods, with selective storage of key information and pre-crafted local data sets that approximate the information available in the vast on-line music information services. A common method of playback in consumer electronics products is by to access the digital audio files from audio CD or CD-R data discs that contain hundreds or thousands of media files or from FLASH memory devices that containing hundreds or thousands of media files.

FIG. 2A shows a connected CD player 32 with local hard drive 34 that can provide the complete functionality of PC-based Media Player 10 of FIG. 1 by accessing on-line music/DVD information service 22 and using TV 36 as an output device. The challenges of implementing such devices have been addressed by several companies such as Escient® (FireBall™), Yamaha® (MusicCAST®), etc.

FIG. 2B shows a connected CD player 42 with limited flash memory 44 which provides a challenge that can be easily overcome if the device has access to a LAN or WAN to provide file storage 46 as if it were local. Many systems, using network file systems or Universal Plug and Play (UPnP) to connect to LAN/WAN file systems 46, are currently deployed such as the Gateway® Connected DVD Player or NETGEAR® Wireless Digital Music Player Model MP101. However, if no LAN/WAN is available then media files will be limited to fixed media (i.e., CD/DVD) or whatever can be stored in local flash memory 44.

FIG. 2C shows a system 42′ that uses a web service 48 to provide storage for managing the content of the CD or CD-R. For a CD the system would first recognize the disc (using CDDB® or a similar on-line music/DVD information service 22) to create a media identifier that could then be associated with that disc for this device. The media library would then store the associated media data and attributes on-line using web service 48 for this purpose. As the user plays more CDs, this information could be tracked by the media library in the web service 48 to provide an experience consistent with that provided by the system illustrated in FIG. 2A.

For CD-R or DVD-R media, the problem is slightly different. Since most CD-R/DVD-R discs are custom-made by users, there is no on-line service to recognize the disc and provide media data and other attributes. These CD-R/DVD-R discs typically contain only a collection of files containing digital music files (e.g., MP3 files), with modest organization to the files. While both the Optical Storage Technology Association (OSTA) and Microsoft®/Panasonic® have proposed specifications (MPV and HighMAT™, respectively) to improve navigation of CD-R and DVD-R discs on consumer electronics devices by adding hierarchical file structure information to the discs, few discs are created using MPV or HighMAT™. Furthermore, MPV and HighMAT™ only address part of the issues addressed by the invention. A system according to the invention would create a unique identifier associated with the disc, so that the laborious process of identifying the contents of a CD-R/DVD-R would happen once by player 42′, and then subsequently the metadata for the contents could be obtained by accessing the media library on-line using web service 48.

Using the capabilities described above, the system 42′ shown in FIG. 2C could be made to function in a consistent manner compared to systems 32 and 42 shown in FIGS. 2A and 2B, while eliminating the costly local hard drive 34 or requirement to access storage 46 via a LAN/WAN. This would provide the side benefit that after a CD-R/DVD-R is “processed” once, thereafter it would be available “instantaneously” whenever the user inserts the CD-R/DVD-R—disc. The user would perceive a consistent experience.

The system shown in FIG. 2D, an unconnected CD player 52 with ROM 54 and limited flash memory 44, provides a bigger challenge. In this case additional data must be stored in ROM such that CDs and digital audio files on personal FLASH audio players, personal FLASH storage devices, or CD-R/DVD-R can be characterized to provide data that “approximates” information retrieved from an on-line music information service. Such data are artist names, artist variant names, related artist information, genre-mapping information, etc.—all data typically retrieved from on-line service 22. Whereas on-line music information service 22 can be relied upon to return information related to each song that is recognized, in an unconnected device the, the intelligence of the programming on the device must be satisfied with the information provided by the digital file 24 itself (e.g., the filename, the filename path if available, and any information contained in the tags of the file 24, such as ID3 tags). The system must utilize any and all of these items to create a “sufficient” set of attributes that can describe the digital file, such that it can be used for creating a playlist, which is a collection of songs to be played that are appropriate to be grouped with other songs for playback.

Many unconnected devices have the ability to play back distinct songs (e.g., digital music files) and even playlists of collections of songs. However, the ability to create an appropriately grouped set of songs for playback in an unconnected device dynamically is limited. Devices such as the Thomson® Lyra® FLASH music player or Apple® iPOD® have done this by dynamically creating a playlist on a connected PC and then “syncing” the playlist (and associated songs) onto the FLASH music player for playback. Others, at best, create a random ordering of a playlist, often referred to as a shuffled playlist. However, according to the present invention, it is possible to provide sophisticated programming logic that examines all the of the data associated with the digital files and create a playlist locally, without being connected to a music information service or syncing data from a connected PC.

Such sophisticated programming logic could rely upon data associated directly with the files (e.g., the filename, the filename path if available, and any information contained in the ID3 tags of the file that may include the artist name, genre, release year of the song, etc.). However, often there is little or no data that can be extracted from the filename, filename path, or ID3 tags other than the song name and artist name. If that is the case, then the programming logic would be able to provide no attributes for use in creating a playlist and any playlists created by the unconnected device would be very unsatisfactory.

To overcome this drawback, according to an aspect of the present invention a targeted set of information is provided that can be used by the programming logic to create better playlists. Experience has shown that the only data that can usually be extracted from a digital music file is the artist name and song name. The artist name can be matched up to a table of artist names using fuzzy string matching, allowing for removal of prepositions (e.g., The or El, Ie, etc.), slight misspellings, removal of punctuation, inverted word order (e.g., Tom Jones or Jones, Tom), etc. Additionally, a table could contain nicknames (e.g., The Beatles or Fab Four) that may increase the ability to match text strings. Once a digital music file has been “matched up” to a table entry, then the attributes for that artist can then be assigned to the digital music file for subsequent playlist generation.

Creating a set of such data that allows an unconnected device to provide the user a consistent experience to that of a connected device, within the tight device ROM storage constraints is made possible by carefully selecting only those artists (and associated attributes) that need to be included in the ROM.

Additionally, the ROM may contain mapping tables for data that may be found in the ID3 tags, so that the data can be used appropriately as an attribute. Mapping tables for genres, geographic regions, eras, etc. are preferably provided in the ROM to assist in providing as many usable attributes for each digital file as possible.

A system according to the present invention provides an automated, scalable, and tunable process that selects arbitrarily sized sets of data that can drive playlist creation in an unconnected device for targeted regions of the world by creating a compact representation of the artist name and attribute data suitable for storage in a ROM.

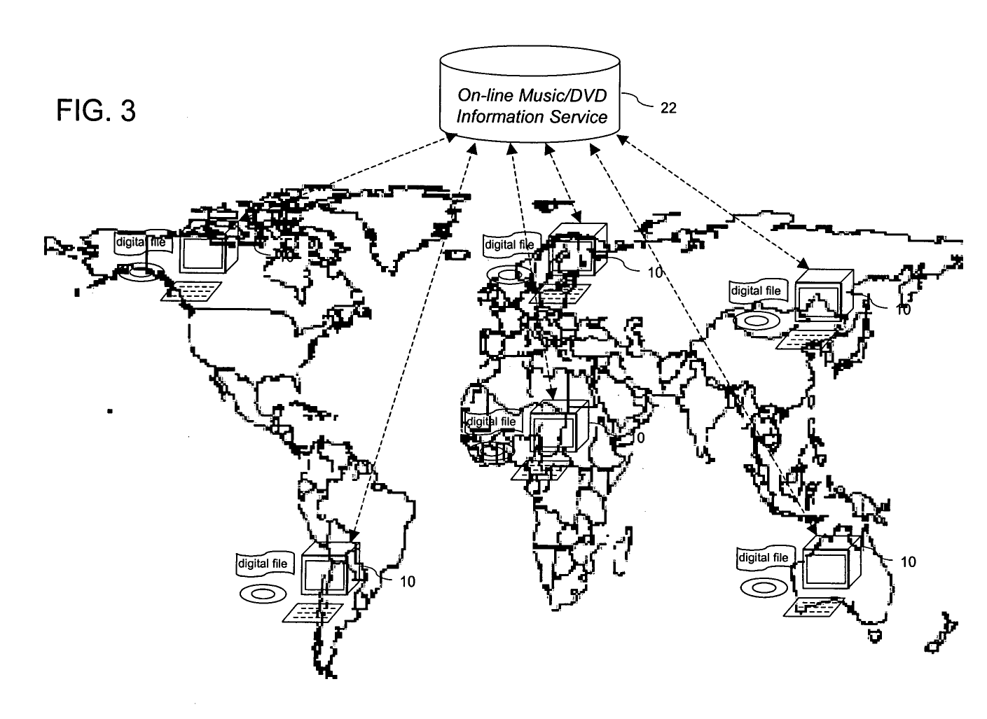

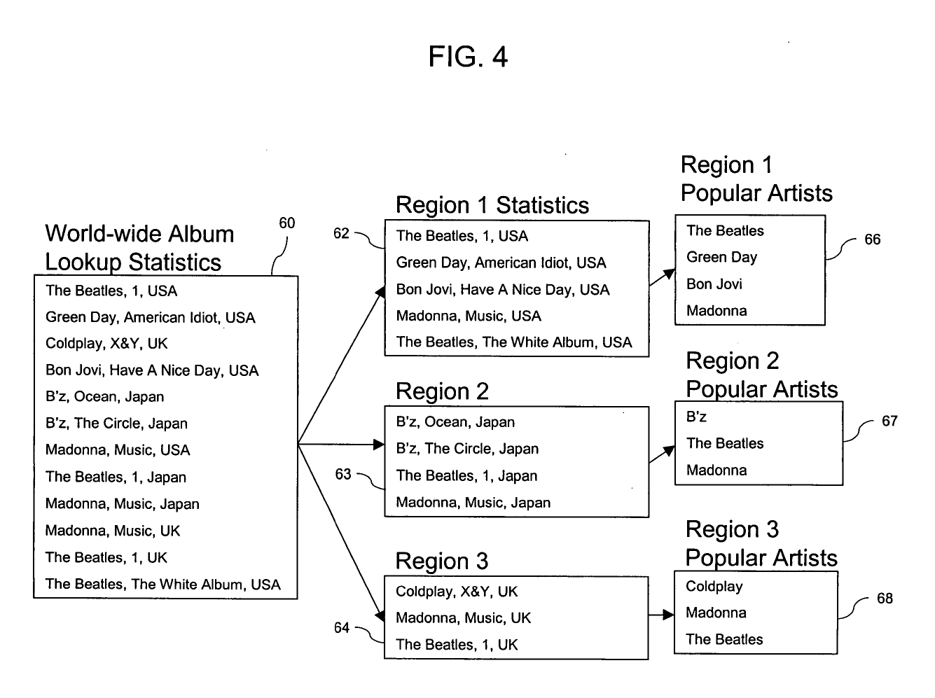

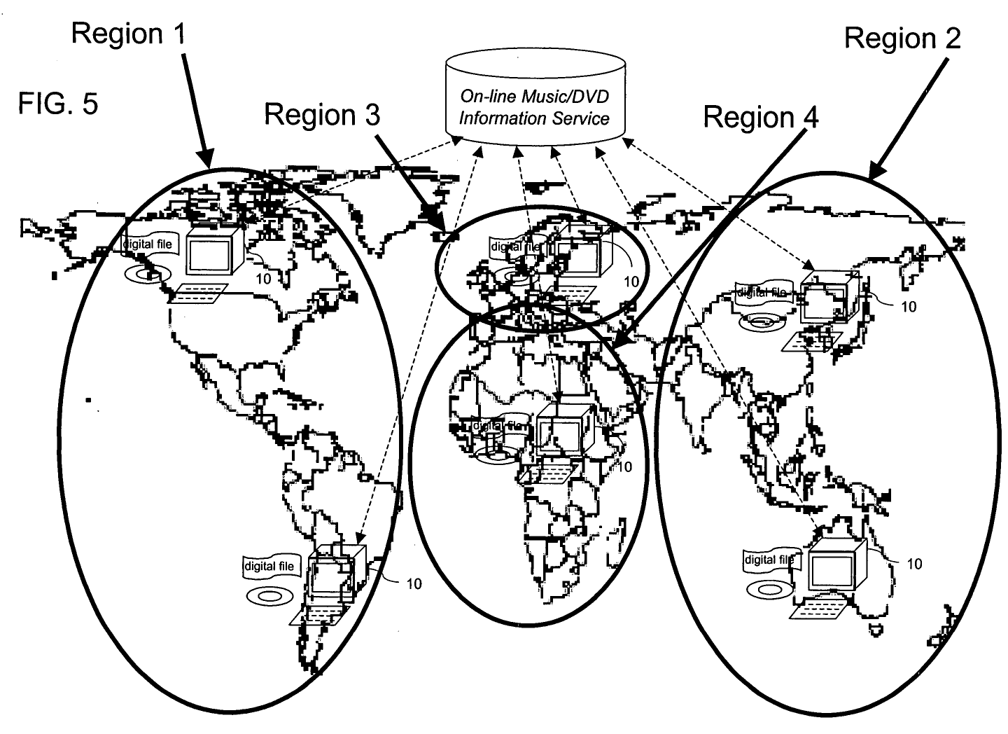

As illustrated in FIG. 3, an on-line music/DVD information service 22, such as CDDB® which is currently used by computers 10 and devices (not shown) throughout world, can collect usage statistics for compact discs that are music albums or other recognition requests, for media such as digital music files or DVD discs. FIG. 4 shows how these usage statistics can be collected and processed by information service 22, by counting the frequency by which the requests for certain media (e.g., compact discs or albums) are recognized. If the information service can collect the location of the requesting PC 10 or device using a technique such as reverse IP mapping like that provided Digital Envoy® in their NetAcuity™ product, then it can also segregate the statistics 60 into regional statistics 62-64 such as DVD region coding areas, as shown in FIG. 5. Furthermore, the regionalized statistics 62-64 can also be used to count and aggregate a list of the most popular artists 66-68 in each region

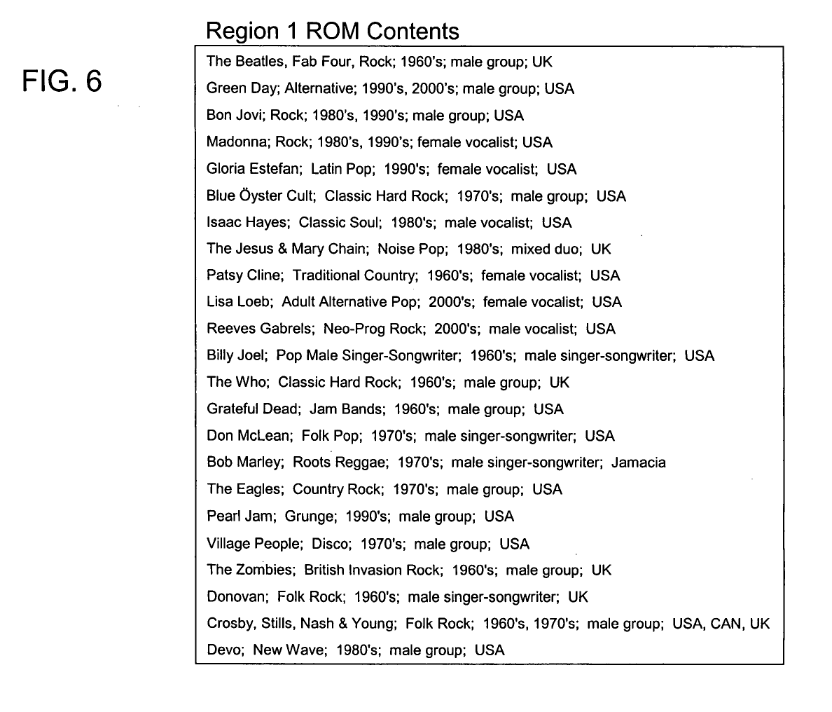

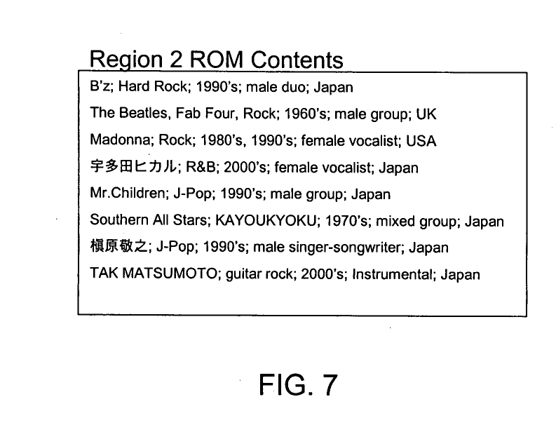

The purpose of creating regional artist lists is to provide a compact set of information, to optimize storage space, that can approximate the information returned from a music information service, such as CDDB®. This would enable custom data sets to be tailored to consumer electronics device distribution regions, optimizing the user experience while minimizing ROM storage requirements. Samples of regional ROM contents are shown in FIGS. 6 and 7.

Of course, all data would be compressed and encrypted for protection. Similarly, string-matching code could be tailored to regions of distribution further reducing code size and related data table size.

As in the system shown in FIG. 2D, CDs and CD-R/DVD-R would be recognized and a modest amount of data related to those unique discs would be stored in flash memory. A small amount of flash memory could be dedicated to storing information related to each CD, CD-R/DVD-R, or digital file to optimize the user's experience.

These various approaches enable a consistent user experience regardless of the consumer electronics device resources or connectivity—powered by worldwide information to optimize embedded data requirements makes this possible.

The invention has been described in detail with particular reference to preferred embodiments thereof and examples, but it will be understood that variations and modifications can be effected within the spirit and scope of the invention covered by the claims which may include the phrase “at least one of A, B, C and D” as an alternative expression that means one or more of A, B, C and D may be used, contrary to the holding in Superguide v. DIRECTV, 69 USPQ2d 1865 (Fed. Cir. 2004).

What is claimed is:

1. A method of selecting metadata for recordings containing audio, comprising:
collecting statistics on playback of the recordings in a plurality of geographic regions;
segregating the statistics and corresponding metadata by the geographic regions; and
selecting a portion of the corresponding metadata for one of the geographic regions based on the statistics.

2. A method as recited in claim 1, further comprising storing the portion of the corresponding metadata in a computer-readable memory.

3. A method as recited in claim 1, wherein said collecting, segregating and selecting are performed automatically by a programmed computer system.

4. A method as recited in claim 1, wherein said selecting includes the corresponding metadata for popular recordings that the statistics indicate are most popular within the one of the geographic regions.

5. A method as recited in claim 4, wherein said selecting further includes the corresponding metadata for additional recordings of at least one of subregions and genres that are under represented in the popular recordings.

6. A method as recited in claim 5, wherein said selecting is repeated for more than one of the geographic regions.

7. A method as recited in claim 6, further comprising storing the portion of the corresponding metadata in a different computer-readable memory each time said selecting is performed for a different geographic region.

8. A method of identifying metadata for recordings containing audio, comprising:
obtaining first metadata associated with a recording;
accessing a selected metadata for a geographical region obtained by
collecting statistics on playback of the recordings in a plurality of geographic regions;
segregating the statistics and corresponding metadata by the geographic regions; and
selecting a portion of the corresponding metadata for one of the geographic regions based on the statistics; and
matching the first metadata with second metadata in the selected metadata.

9. A method as recited in claim 8, wherein said obtaining includes reading at least one of a filename, a filename path and an ID3 tag of the recording.

10. A method as recited in claim 9, wherein the selected metadata include at least one of artist names, artist variant names, related artist information, genre-mapping information, release year, type of artist and country of origin.

11. A method of generating playlists, comprising:
accessing metadata identified in accordance with the method recited in claim 8 for a set of recordings containing audio; and
selecting related recordings from the set of recordings to form a playlist, where the related recordings have matching values for at least one type of the metadata; thereby creating a consistent user experience for a range of consumer electronics devices, regardless of on-line connectivity capabilities and local storage capacity.

12. A method as recited in claim 11, wherein the metadata include at least one of artist names, artist variant names, related artist information, genre-mapping information, release year, type of artist and country of origin.

13. An apparatus for playback of recordings containing audio, comprising:
a memory storing selected metadata for a geographical region obtained by collecting statistics on playback of the recordings in a plurality of geographic regions, segregating the statistics and corresponding metadata by the geographic regions and selecting a portion of the corresponding metadata for the geographic region based on the statistics.

14. An apparatus as recited in claim 13, further comprising a processor programmed to obtain first metadata associated with a recording, access the selected metadata and match the first metadata with second metadata in the selected metadata.

15. An apparatus as recited in claim 14, wherein said processor is further programmed to access first and second metadata for a set of the recordings and select related recordings from the set of recordings to form a playlist, where the related recordings have matching values for at least one type of the metadata; thereby creating a consistent user experience for a range of consumer electronics devices, regardless of on-line connectivity capabilities and local storage capacity.

16. At least one computer readable medium storing instructions that when executed control a processor to perform a method of selecting metadata for recordings containing audio, said method comprising:
collecting statistics on playback of the recordings in a plurality of geographic regions;
segregating the statistics and corresponding metadata by the geographic regions; and
selecting a portion of the corresponding metadata for one of the geographic regions based on the statistics.

17. At least one computer readable medium as recited in claim 16, said method further comprising storing the portion of the corresponding metadata in a computer-readable memory.

18. At least one computer readable medium as recited in claim 16, wherein said collecting, segregating and selecting are performed automatically by a programmed computer system.

19. At least one computer readable medium as recited in claim 16, wherein said selecting includes the corresponding metadata for popular recordings that the statistics indicate are most popular within the one of the geographic regions.

20. At least one computer readable medium as recited in claim 19, wherein said selecting further includes the corresponding metadata for additional recordings of at least one of subregions and genres that are under represented in the popular recordings.

21. At least one computer readable medium as recited in claim 20, wherein said selecting is repeated for more than one of the geographic regions.

22. At least one computer readable medium as recited in claim 21, said method further comprising storing the portion of the corresponding metadata in a different computer-readable memory each time said selecting is performed for a different geographic region.

23. At least one computer readable medium storing instructions that when executed control a processor to perform a method of identifying metadata for recordings containing audio, said method comprising:
obtaining first metadata associated with a recording;
accessing a selected metadata for a geographical region obtained by
collecting statistics on playback of the recordings in a plurality of geographic regions;
segregating the statistics and corresponding metadata by the geographic regions; and
selecting a portion of the corresponding metadata for one of the geographic regions based on the statistics; and
matching the first metadata with second metadata in the selected metadata.

24. At least one computer readable medium as recited in claim 23, wherein said obtaining includes reading at least one of a filename, a filename path and an ID3 tag of the recording.

25. At least one computer readable medium as recited in claim 24, wherein the selected metadata include at least one of artist names, artist variant names, related artist information, genre-mapping information, release year, type of artist and country of origin.

26. At least one computer readable medium storing instructions that when executed control a processor to perform a method of generating playlists, said method comprising:
accessing metadata identified in accordance with the method recited in claim 8 for a set of recordings containing audio; and
selecting related recordings from the set of recordings to form a playlist, where the related recordings have matching values for at least one type of the metadata; thereby creating a consistent user experience for a range of consumer electronics devices, regardless of on-line connectivity capabilities and local storage capacity.

27. At least one computer readable medium as recited in claim 26, wherein the metadata include at least one of artist names, artist variant names, related artist information, genre-mapping information, release year, type of artist and country of origin.
